(19) United States
(12) Patent Application Publication
(10) Pub. No.: US 2019/0335307 A1
(43) Pub. Date: Oct. 31, 2019

(54) SELF-REPORTING LOCATION AND URGENCY ESTIMATE OF EMERGENCY CALLS

(71) Applicant: International Business Machines Corporation, Armonk, NY (US)

(72) Inventors: Mauro Marzorati, Lutz, FL (US); Gary F. Diamanti, Wake Forest, NC (US); Aaron K. Baughman, Silver Spring, MD (US); John F. McKay, JR., Chicago, IL (US)

(73) Assignee: International Business Machines Corporation, Armonk, NY (US)

(21) Appl. No.: 15/963,721

(22) Filed: Apr. 26, 2018

(51) Int. Cl. H04W 4/90; H04W 4/029

(52) U.S. Cl. CPC H04W 4/90; H04W 4/029

(57) ABSTRACT

A message is received from a mobile telecommunication device (device), including location data and an emergency data item, and in response to a call being initiated to an emergency service from the device. A degree of correspondence is computed between the message and a pattern of messages, the pattern having been computed using a set of past messages. A degree of concurrency of the message is determined with any other message received during a period in which the message is received. Using a function on the degree of correspondence and the degree of concurrence, a level of urgency is estimated that is associated with the call from the device to the emergency service. The location data and the level of urgency are made available to the emergency service.

### TECHNICAL FIELD

The present invention relates generally to a method, system, and computer program product for providing information that is useful in responding to telephone calls made to the emergency numbers. More particularly, the present invention relates to a method, system, and computer program product for self-reporting location and urgency estimate of emergency calls.

### BACKGROUND

Hereinafter, a “call” refers to an electronic transmission and/or reception of voice using a voice telecommunication device. Hereinafter, an “emergency number” refers to an identifier, e.g., a telephone number, of a service that responds to one or more types of perils, hazards, or emergencies. The identifier can be used to place a call from a telecommunication device to the emergency service. 9-1-1 is an example of an emergency number that can be dialed to reach a service that can dispatch police, fire brigades, ambulances, and other personnel and equipment in response to an emergency.

Initially all telephones were landline, with known/fixed addresses associated with the caller's subscriber number. However, with the advent of cell phones and other mobile telecommunication devices, a shift has occurred that subscriber identifiers (e.g., phone numbers) associated with the devices more accurately describe a caller not a physical location. Correspondingly, the assumption that the location of the caller matches their subscriber billing address has been broken. About 70 percent of 9-1-1 calls came from cell phones in 2014 and finding out where the calls came from required triangulation. A study showed that where information was compiled on the subject, many of the calls from cell phones did not include information allowing the caller to be located. Chances of getting as close as 100 feet were higher in areas with more towers. But if a call was made from a large building, even that would not be enough to precisely locate the caller. New federal rules, which service providers helped with, require location information for 40 percent of calls by 2017 and 80 percent by 2021. As recently as 21 Apr. 2016, an unidentified caller dialing 9-1-1 to report the death of a famous musical artist still needed to provide the 9-1-1 dispatcher with the physical address of the building in which the musician had died because the dispatcher had no other means to determine the location of the caller's cell phone. The caller was asked to locate a piece of mail with the building's address so that emergency responders could be sent.

This was a problem with so-called feature phones which lack the smarts to be able to report their position. A scheme was put in place to have the cell tower augment the location information. Modern smart phones and other telecommunication devices have inherited this scheme even though they do indeed have the capability to know their position.

In most areas (approximately 96 percent of the U.S.), enhanced 9-1-1 (E-911 or E911) is available, which automatically gives the emergency dispatcher the caller's location, if available. In all North American jurisdictions, special privacy legislation permits emergency operators to obtain a 9-1-1 caller's telephone number and location information. Presently, this information is gathered by mapping the calling phone number to a fixed address in a database. This address-mapping function is known as Automatic Location Identification (ALI).

The database is generally maintained by the local telephone company, under a contract with the Public Safety Answering Point (PSAP). Each telephone company has its own standards for the formatting of the database. Most ALI databases have a companion database known as the MSAG, Master Street Address Guide. The MSAG describes address elements including the exact spellings of street names, and street number ranges. In the case of mobile telecommunication devices, the associated billing address is not necessarily the location to which emergency responders should be sent, since the device is portable. This means that locating the caller is more complicated, and there are a different set of legal and technical requirements.

To locate a mobile telephone geographically, two general approaches are presently used: to use some form of radio-location from the cellular network or to use a Global Positioning System (GPS) receiver built into the phone itself. Both approaches are described by the radio resource location services protocol (LCS protocol). Depending on the telecommunication device hardware, one of two types of location information can be provided to the operator. The first is Wireless Phase One (WPH1) which is the tower location and the direction the call came from, and the second is Wireless Phase Two (WPH2) which provides an estimated GPS location of the device.

As Voice over Internet Protocol (VoIP) technology matured, service providers began to interconnect VoIP with the public switched telephone network and marketed the VoIP service as a cheap replacement phone service. However, E911 regulations and legal penalties have severely hampered the more widespread adoption of VoIP: VoIP is much more flexible than landline phone service, and there is no easy way to verify the physical location of a caller on a nomadic VoIP network at any given time (especially in the case of wireless networks), and so many providers offered services which specifically excluded 9-1-1 service so as to avoid the severe E-911 non-compliance penalties. VoIP services tried to improvise, such as routing 9-1-1 calls to the administrative phone number of the PSAP, adding on software to track phone locations, etc.

In response to the E911 challenges inherent to IP phone systems, specialized technology has been developed to locate callers in the event of an emergency. Some of these new technologies allow the caller to be located down to the specific office on a particular floor of a building. These solutions support a wide range of organizations with IP telephony networks. The solutions are available for service providers offering hosted IP PBX and residential VoIP services. This increasingly important segment in IP phone technology includes E911 call routing services and automated phone tracking appliances. Many of these solutions have been established according to FCC, CRTC, and NENA i2 standards, in order to help enterprises and service providers reduce liability concerns and meet E911 regulations.

### SUMMARY

The illustrative embodiments provide a method, system, and computer program product. An embodiment includes a method that receives, from a mobile telecommunication device (device), a message comprising location data and an emergency data item, the message being responsive to a call being initiated to an emergency service from the device. The embodiment computes a degree of correspondence between the message and a pattern of messages, the pattern having been computed using a set of past messages. The embodiment determines a degree of concurrency of the message with any other message received during a period in which the message is received. The embodiment estimates, using a processor and a memory, using a function on the degree of correspondence and the degree of concurrence, a level of urgency associated with the call from the device to the emergency service. The embodiment makes the location data and the level of urgency available to the emergency service.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for self-reporting location and urgency estimate of emergency calls in accordance with an illustrative embodiment;

FIG. 4 depicts a flowchart of an example device-side process for self-reporting location and urgency estimate of emergency calls in accordance with an illustrative embodiment; and

FIG. 5 depicts a flowchart of an example server-side process for self-reporting location and urgency estimate of emergency calls in accordance with an illustrative embodiment.

### DETAILED DESCRIPTION

The illustrative embodiments recognize that regardless of the methods presently put in place to provide location information to emergency dispatchers, the methods suffer from three major drawbacks. First, even if the mobile telecommunication device is capable of determining and providing its own location, the presently available systems cause the device to provide this information in-line with the call, in the manner of the caller ID service. Stated another way, the location data uses the same path from the device to the dispatcher as the data packets of the voice call do. This pathing of the location data is not very reliable for the same reasons that the mobile voice calls are often not reliably connected.

Second, if the device is incapable of determining or providing its own location, external and proprietary software solutions have to be employed to locate the device (and the caller). In many cases, the device might maintain the capability to determine its own location but lose the ability to provide that location to the dispatcher.

Lastly, even if the location information is made available to the dispatcher in-line with the call or by external software tools, the dispatcher still has to manually determine a level of urgency related with the call. For example, some people are habitual abusers of the emergency system for less-than-legitimate and non-emergency purposes. Furthermore, not all emergencies are equal in the urgency of the response that is required. A cat up the tree is a less urgent emergency than a house on fire.

The illustrative embodiments recognize that a need exists for reliable communication of the location data from portable telecommunication devices such that the transmission of the location data is dependent only on the network connectivity of the device and not on the in-line channel properties of the call itself. The illustrative embodiments further recognize a need for data transmission in this manner where the data includes not just the location of the device but also other information that could be useful to the dispatcher and others in responding to the emergency. The illustrative embodiments also recognize that any assistance the dispatcher can get via automatic estimation of a level of urgency likely to be associated with an emergency call is useful in efficient handling of the call.

The illustrative embodiments recognize that the presently available tools or solutions do not address these needs/problems or provide adequate solutions for these needs/problems. The illustrative embodiments used to describe the invention generally address and solve the above-described problems and other related problems by self-reporting location and urgency estimate of emergency calls.

An embodiment can be implemented as a software application. The application implementing an embodiment, or one or more components thereof, can be configured as a modification of an existing mobile telecommunication device—i.e., a native application in the device, as an application executing in a data processing system communicating with an existing mobile telecommunication device, as a separate application that operates in conjunction with an existing telecommunications system in other ways, a standalone application, or some combination thereof.

An embodiment (device embodiment) provides operations that are executed in a mobile telecommunication device. Another embodiment (server embodiment) provides operations that are executed in a mobile telecommunication device. An embodiment provides operations that can be executed entirely on or from the server. These examples of distribution of the various operations are not intended to be limiting. From this disclosure, those of ordinary skill in the art will be able to conceive many other ways in which to distribute the described operations to a mobile telecommunication device, a server data processing system, or both, and such other distributions are contemplated within the scope of the illustrative embodiments.

A control channel in a wireless connectivity of a mobile telecommunication device is a data communication path that is used to establish and maintain the device's connectivity with the wireless base station. Whether or not the device is actually making a call using the connectivity, the device and the base station exchange data over the control channel to maintain the device's connection to the base station. Text messaging facility, also known as Short Message Service (SMS), piggybacks the data of a text message with the control messages onto the control channel. As long as the device can establish and maintain a connection with a base station on a tower, the text message will go through even if the connection is insufficient to establish a voice call. Control channel messaging is also known as out-of-band messaging.

A text message or SMS message contemplated herein is not limited to only textual data, but can also include graphical, audio, and/or video data, depending upon the messaging feature of a particular control channel implementation.

The illustrative embodiments utilize out-of-band messaging to deliver data out from the mobile telecommunication device. An embodiment packages and communicates the data as a text message from the device to a destination.

The data being packaged as text message includes not only the location of the device but data items from an emergency data profile as well. An embodiment maintains an emergency data profile (EDP) in the device. The EDP includes a preconfigured destination for the data that will be transmitted as text message. The preconfigured destination can be, but is preferably not, the identifier of the emergency service, e.g., not 9-1-1. The preconfigured destination can be, but is not limited to a website, a server-based application, or generally a data processing configuration that is accessible by the general member of the public with or without access control. Emergency service data processing systems are not accessible by the general member of the public and access to such systems is highly restricted for a variety of reasons. A destination of the text message employs one or more operations of an embodiment described herein.

The EDP according to an embodiment includes, but is not limited to, user-defined targets who can receive notification of an emergency from the preconfigured destination, when the user makes a call to the emergency service. A user-defined target can be, for example, a next-of-kin, an “In Case of Emergency (ICE) contact,” etc. the EDP may also optionally include a social media identifier of the user, an identifier—e.g. a phone number—associated with the user, or some combination thereof. The one or more identifiers are usable at the destination for identifying the user who made the emergency call, selecting a group of users who should be able to receive notification or other publication of the data of the text message, or for applying other controls on the manner in which the data of the text message is to be shared with the emergency dispatcher and the members of the public.

An embodiment initiates the text message upon detecting that a call is being placed to an identifier associated with an emergency service. While the call to the emergency service is in progress—i.e., whether being attempted or while connected—the embodiment periodically or from time to time refreshes the data with the latest location of the device and other changeable data items in the EDP. The embodiment sends one or more updated text messages to the destination while the call remains in progress.

An embodiment at the preconfigured destination receives the text message. The embodiment manages a historical repository of text messages received from one or more users over a period. The embodiment analyzes the data payloads of historical text messages to compute a pattern in the messages. Within the scope of the illustrative embodiments, a pattern can comprise one or more time intervals between messages, one or more senders of the messages, one or more locations from which the messages originate, one or more times of the day when the messages are received, or a combination of these and many other aspects of text messages as will be apparent from this disclosure to those of ordinary skill in the art.

For example, one pattern may be sender/caller specific, i.e., a frequency with which a subject caller calls the emergency service, thereby triggering the text messages to the embodiment at the destination. The occurrences of the text messages from a particular caller may be sporadic with no perceptible pattern, periodic with some regularity within a tolerance, or a combination thereof over a period. While regular periodicity readily forms a pattern, under certain circumstances, even sporadic messages from the same sender can be construed as a pattern—that the sender is a repeat sender.

Another example pattern may be location specific, i.e., a geographical location or area from which one or more callers call the emergency service, thereby triggering the text messages to the embodiment at the destination. The occurrences of the text messages from a particular location or area may be sporadic with no perceptible pattern, periodic with some regularity within a tolerance, or a combination thereof over a period. While regular periodicity readily forms a pattern, under certain circumstances, even sporadic messages from the same location or area can be construed as a pattern—that the location or area is a site of repeat emergencies.

Another example pattern may be caller-group specific, i.e., a particular group of callers calls the emergency service, thereby triggering the text messages to the embodiment at the destination. The occurrences of the text messages from one or more user members of a particular group may be sporadic with no perceptible pattern, periodic with some regularity within a tolerance, or a combination thereof over a period. While regular periodicity readily forms a pattern, under certain circumstances, even sporadic messages from the same group can be construed as a pattern—that the group is a repeat observer of emergencies.

Another example pattern may be condition specific, i.e., calls to the emergency service from a caller, group, or location are received when a certain condition is true or observed. The occurrences of the text messages relating to the condition may be sporadic with no perceptible pattern, periodic with some regularity within a tolerance, or a combination thereof over a period. While regular periodicity readily forms a pattern, under certain circumstances, even sporadic messages relating to the same condition can be construed as a pattern—that the condition has repeatedly been associated with emergencies of the caller, group, or location.

These examples of patterns are not intended to be limiting. From this disclosure, those of ordinary skill in the art will be able to conceive many other patterns and the same are contemplated within the scope of the illustrative embodiments.

According to an embodiment, a pattern is indicative of a degree or level of urgency associated with the emergency being reported. Accordingly, the embodiment evaluates a particular incoming text message to determine whether the text message fits one or more patterns determined from the historical messages. The embodiment computes a level of urgency associated with the emergency being reported in the call that triggered the text message as a function of a degree of fit between the incoming text message and a previously determined pattern.

An embodiment at the preconfigured destination also determines whether an incoming text message is concurrent with one or more other text messages within a threshold period. The concurrency of the text messages has an additional aspect that the concurrent text messages are being concurrently received from the same geographical location or area within the threshold period. More than one text messages triggered by callers calling emergency services from the same general location or area is indicative of a severity or urgency of the one or more emergencies being reported from the location or area.

The embodiment computes a level of urgency associated with the emergency being reported in the call that triggered the text message as a function of a number of concurrent text messages being received from the same general location or area. One embodiment computes the level of urgency as a function of both—the pattern fit described herein and the concurrency described herein.

An embodiment publishes some or all of the contents of the incoming text message and the computed level of urgency for the emergency associated with the call that triggered the text message. The publishing may include, but is not limited to, publishing to—a website associated with the preconfigured destination, a social media associated with a social media identifier in the text message, an additional destination specified in the EDP data items of the text message, an emergency service center or dispatch system, or some combination thereof.

The publishing enables a dispatcher to quickly obtain—either directly and/or through the publication elsewhere—the location information from the mobile telecommunication device regardless of whether the emergency call from that device is successfully connected with the dispatcher. The dispatcher is also able to obtain additional information from the text message, which the dispatcher presently has to manually collect if the call is successfully connected. Furthermore, one or more members of the public can also obtain the information about the reported emergency, location of the emergency, and additional information as may have been configured via the EDP on the texting device.

The manner of self-reporting location and urgency estimate of emergency calls described herein is unavailable in the presently available methods. A method of an embodiment described herein, when implemented to execute on a device or data processing system, comprises substantial advancement of the functionality of that device or data processing system in out-of-band publishing of the location and other data related to an emergency along with an estimated level of urgency associated with the emergency.

The illustrative embodiments are described with respect to certain types of emergencies, services, wireless links, messages, data items, patterns, concurrencies, levels of urgency, manners of publishing, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

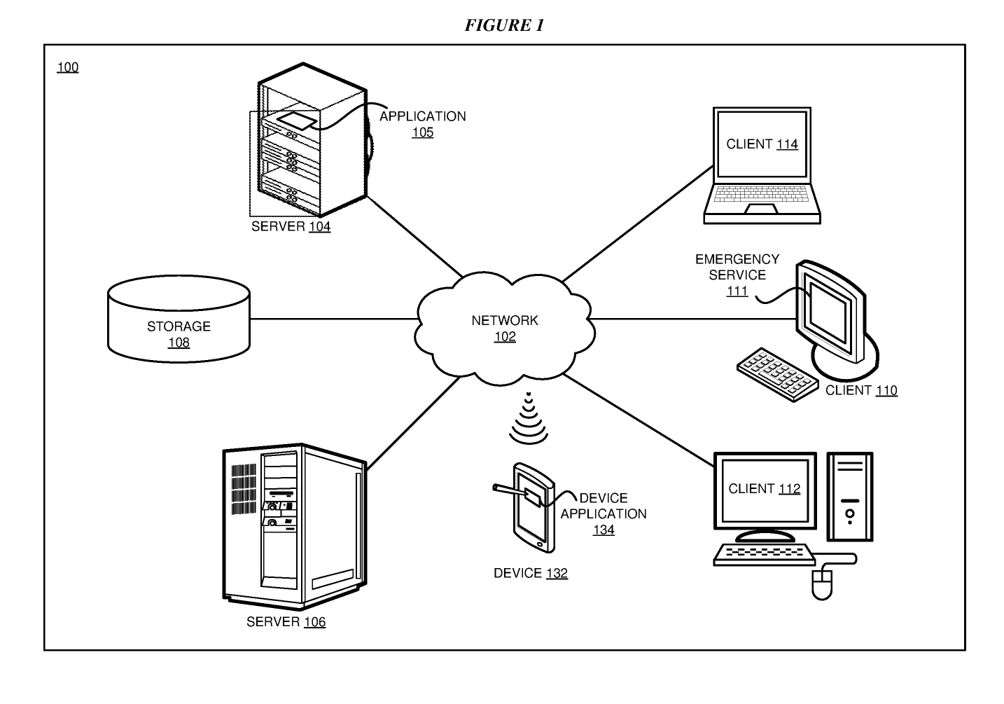

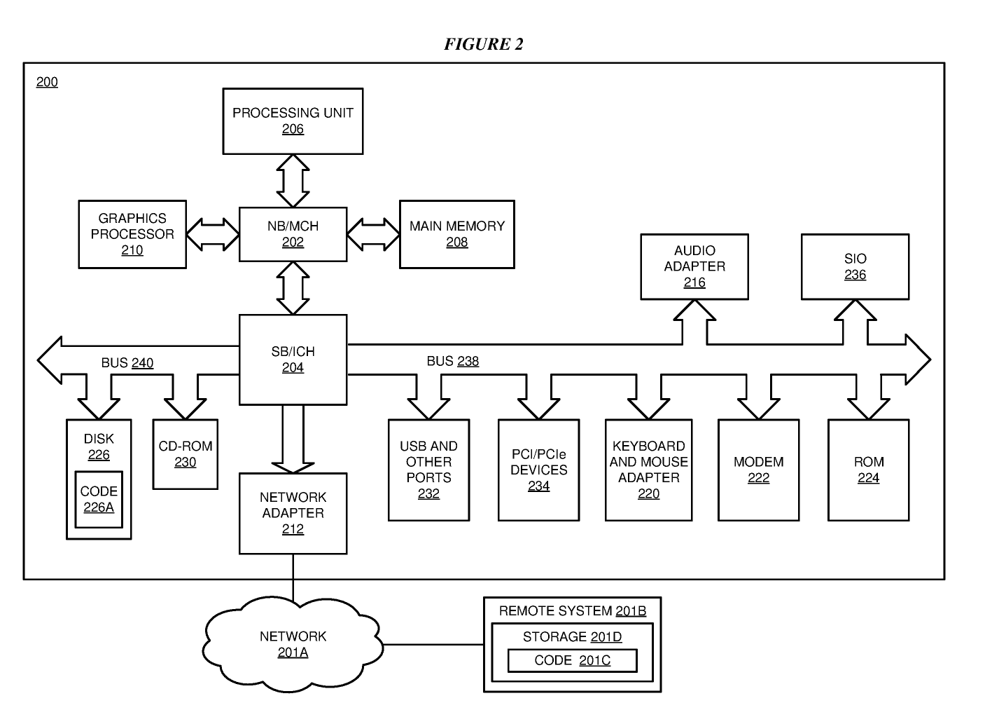

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as examples and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is a non-limiting example of a mobile telecommunication device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment, e.g., a server-side operation of an embodiment described herein. Device application 134 implements another embodiment, e.g., a device-side operation of an embodiment described herein. Emergency service 111 is an example of a dispatch system available to an emergency service dispatcher.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 and 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

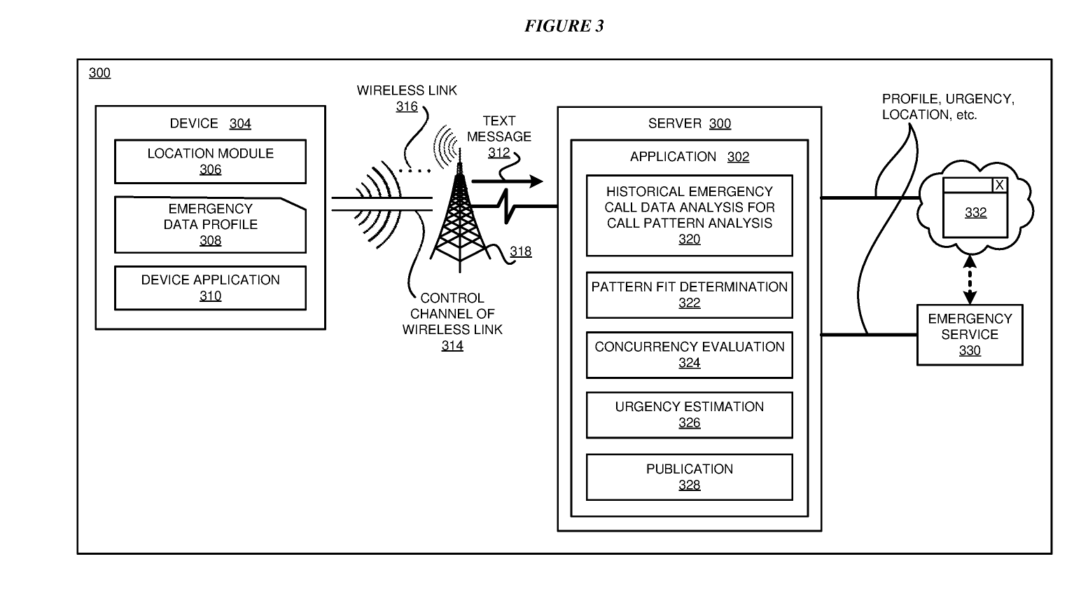

With reference to FIG. 3, this figure depicts a block diagram of an example configuration for self-reporting location and urgency estimate of emergency calls in accordance with an illustrative embodiment. Server 300 is an example of server 104 and application 302 is an example of application 105 in FIG. 1. Server 300 may be affiliated with a destination that receives text messages, which are sent as a result of initiating emergency calls from mobile telecommunication device 304.

Device 304 is an example of device 134 in FIG. 1 and includes location module 306. Location module 306 may be configured in any suitable manner to collect or compute a location of device 304. The location data collected or computed by module 306 may take any suitable form, including but not limited to longitude-latitude (and optionally altitude), street address, geographical reference to a structure or place, a position within or relative to the structure or place, or a combination thereof.

Device 304 is further configured with EDP 308. EDP 308 can comprise one or more of the example data items described herein, or similarly purposed different or additional data items. Furthermore, EDP 308 can be constructed and stored as any suitable data structure in device 304.

Device application 310 is an example of device application 134 in FIG. 1. Application 310 triggers text message 312 using data items from EDP 308 when device 304 initiates an emergency call. In one case, application 310 may be a reconfiguring of an existing text messaging utility in device 304 to trigger text message 312 using EDP 308 when device 304 initiates an emergency call.

Application 310 causes text message 312 to use control channel 314 of wireless link 316, which is established between device 304 and wireless or cellular infrastructure component 318.

Application 302 receives text message 312. Over a period, application 302 receives a plurality of text messages, from different users, at different times, from different locations, or some combination thereof. Component 320 analyzes the data contained in such past messages to determine one or more patterns as described herein.

Component 322 computes whether text message 312 fits or corresponds to any of the patterns of past messages. Component 324 performs a concurrency evaluation for text message 312, i.e., whether text message 312 is concurrent with one or more other text messages in a manner described herein.

Component 326 uses the pattern-fit determination from component 322 and/or concurrency determination from component 324 to compute a level of urgency associated with a call that caused text message 312 to be sent from device 304.

Component 328 publishes at least the location data contained in text message 312. Component 328 also publishes the computed level of urgency associated with the triggering call of text message 312.

Component 328 may also publish one or more EDP data items from text message 312 as may be configured in application 302, by a user of device 304, or both. Furthermore, component 328 may publish different subsets of data to different destinations. For example, component 328 may publish the location, the level of urgency, and all available EDP data items to emergency service 330, but only the location and the level of urgency to website 332 for the public, and only the location and a subset of EDP data items to an additional contact in EDP 308. These examples of publications are not intended to be limiting. From this disclosure, those of ordinary skill in the art will be able to conceive many other ways in which the available information can be published to different destinations and the same are contemplated within the scope of the illustrative embodiments.

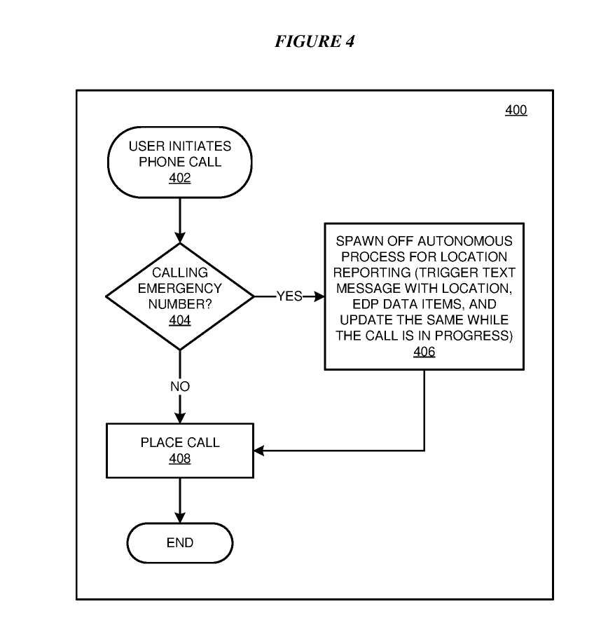

With reference to FIG. 4, this figure depicts a flowchart of an example device-side process for self-reporting location and urgency estimate of emergency calls in accordance with an illustrative embodiment. Process 400 can be implemented in device application 310 in FIG. 3.

The application detects that a phone call is being initiated at the mobile telecommunication device (block 402). The application determines whether the call is directed to a number that is configured as an emergency number (block 404). If the call is directed to an emergency number (“Yes” path of block 404), the application begins an autonomous process, i.e. a process that executes separately from the process associated with the call (block 406). Particularly, at block 406, the autonomous process triggers a text message as described herein, containing at least the location of the device and one or more data items from the EDP. Furthermore, the autonomous process triggers subsequent text messages with updated information, if needed, while the call to the emergency number is in progress as described herein.

The application, after spawning the autonomous process at block 406, allows the call to be placed (block 408). If the call is not directed to an emergency number (“No” path of block 404), the application proceeds to block 408 and allows the call to progress normally. The application ends process 400 thereafter.

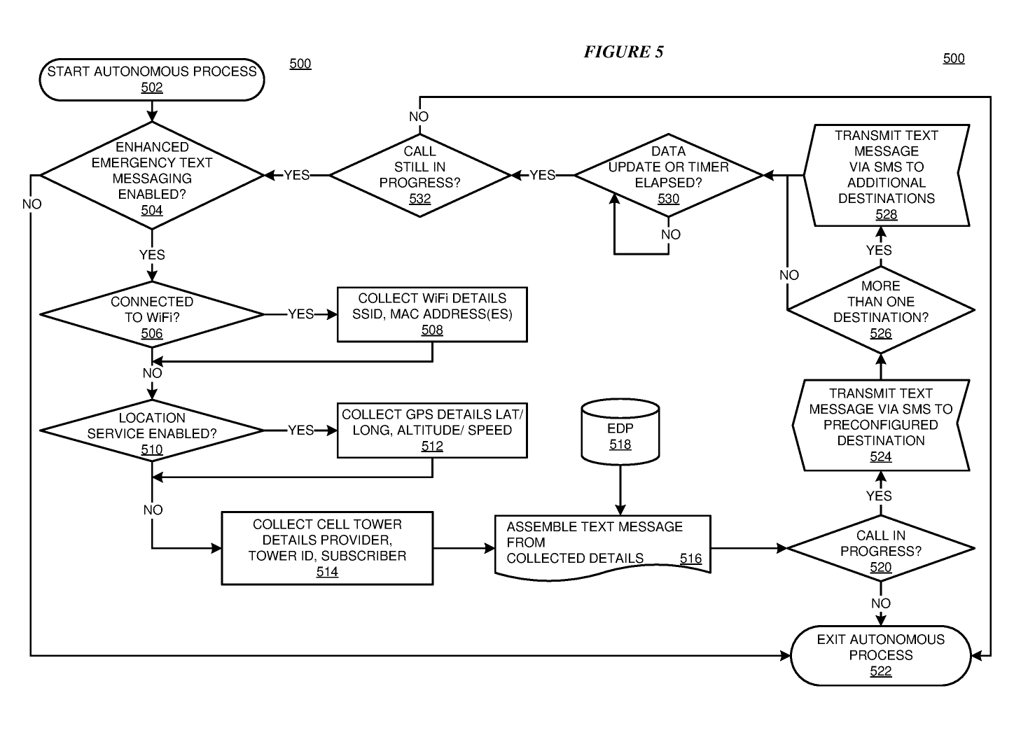

With reference to FIG. 5, this figure depicts a flowchart of an example server-side process for self-reporting location and urgency estimate of emergency calls in accordance with an illustrative embodiment. Process 500 can be implemented in application 302 in FIG. 3.

The application starts the autonomous process of block 406 (block 502). The application determines whether emergency call-triggered text messaging, as described herein, is enabled (block 504). If emergency call-triggered text messaging is not enabled (“No” path of block 504), the application exits the autonomous process at block 522. messaging, as described herein, is enabled (block 504).

If emergency call-triggered text messaging is enabled (“Yes” path of block 504), the application attempts to collect as many types of location information as may be possible. For example, the application may determine whether the device is connected to a Wi-Fi network (block 506). If so (“Yes” path of block 506), the application collects Wi-Fi details such as SSID, MAC address etc. (block 508), which are usable to identify the location of the device as described herein. If not (“No” path of block 508), the application attempts to determine the location of the device in other ways.

As another example, the application may determine whether the location service in the device is enabled (block 510). If so (“Yes” path of block 510), the application collects location details such as the latitude, longitude, altitude, and velocity (block 512), which are usable to identify the location of the device as described herein. If not (“No” path of block 510), the application attempts to determine the location of the device in other ways.

If a type of location information cannot be established from blocks 508 or 512, or in addition to the information from blocks 508 and 512, the application also collects other information usable to establish the device's location. For example, the application determines the cell tower(s) to which the device is, or can be, wirelessly linked (block 514). The application may also identify the identifiers of such towers, service provider details, and applicable subscriber details to facilitate using a database-based device-location in a manner described herein.

Once at least some type of location information is available to the application, the application proceeds to assemble the text message, e.g., text message 312 in FIG. 3, (block 516). For example, the application may utilize EDP 518 configured in the device to populate the text message.

The application determines whether the emergency call is still in progress (block 520). If the call is no longer in progress (“No” path of block 520), the application ends the autonomous process at block 522. If the call is in progress (“Yes” path of block 520), the application transmits the text message via the control channel f a wireless link to a preconfigured destination for such messages (block 524). If the user has configured more than one destination for the text message (“Yes” path of block 526), the application transmits the text message to additional destinations in a suitable manner, preferably also via the control channel (block 528). If the user has not configured more than one destination for the text message (“No” path of block 526), the application proceeds to block 530.

The application determines whether the location of the device or some other information in the EDP has changed, or a timer has elapsed (block 530). If no data has changed, and the timer has not elapsed (“No” path of block 530), the application waits for at least one of these events to occur. If the location of the device or some other information in the EDP has changed, or the timer has elapsed (“Yes” path of block 530), the application determines whether the call is still in progress (block 532).

If the call is still in progress (“Yes” path of block 532), the application returns to block 504 and proceeds therefrom. If the call is no longer in progress (“No” path of block 532), the application ends the autonomous process at block 522.

Thus, a computer implemented method, system or apparatus, and computer program product are provided in the illustrative embodiments for self-reporting location and urgency estimate of emergency calls and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, including but not limited to computer-readable storage devices as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising:
receiving, from a mobile telecommunication device (device), a message comprising location data and an emergency data item, the message being responsive to a call being initiated to an emergency service from the device;
causing the emergency call initiation to compute the location data at the device;
causing a construction of the message at the device using an emergency data profile;
computing a degree of correspondence between the message and a pattern of messages, the pattern having been computed using a set of past messages from the device;
determining a number of other messages received within a time period shorter than a threshold time period during which the message is received, the other messages being received from a plurality of devices other than the device;
estimating, using a processor and a memory, using a function on the degree of correspondence and the number of other messages, a level of urgency associated with an emergency reported in the call from the device to the emergency service; and
making the location data and the level of urgency available to the emergency service.

2. (canceled)

3. The method of claim 1, wherein the emergency data profile is configured within the device.

4. The method of claim 1, wherein the message comprises textual data.

5. The method of claim 1, further comprising:
receiving the set of past messages over a past period, the past period occurring prior to the period in which the message is received, wherein the pattern comprises an amount of elapsed time between a pair of past messages, and wherein the degree of correspondence indicates that the message arrived after the amount of elapsed time after an earlier message and the location data of the message and location data of the earlier message indicate locations in a common geographical area.

6. The method of claim 1, further comprising:
receiving the set of past messages over a past period, the past period occurring prior to the period in which the message is received, wherein the pattern comprises a sender of a past message in the past messages, and wherein the degree of correspondence indicates that a sender of the message is also a sender of an earlier message.

7. The method of claim 1, further comprising:
receiving the set of past messages over a past period, the past period occurring prior to the period in which the message is received, wherein the pattern comprises a location information contained in a past message in the past messages, and wherein the degree of correspondence indicates that the location data of the message and location data of an earlier message indicate locations in a common geographical area.

8. The method of claim 1, further comprising:
receiving the set of past messages over a past period, the past period occurring prior to the period in which the message is received, wherein the pattern comprises a group of senders who sent a subset of the past messages.

9. The method of claim 1, wherein the location data of the message and location data of the number of other messages indicate locations in a common geographical area.

10. The method of claim 1, further comprising:
publishing the location data and the level of urgency to another user.

11. A computer usable program product comprising a computer-readable storage device, and program instructions stored on the storage device, the stored program instructions comprising:
program instructions to receive, from a mobile telecommunication device (device), a message comprising location data and an emergency data item, the message being responsive to a call being initiated to an emergency service from the device;
program instructions to cause the emergency call initiation to compute the location data at the device;
program instructions to cause a construction of the message at the device using an emergency data profile;
program instructions to compute a degree of correspondence between the message and a pattern of messages, the pattern having been computed using a set of past messages from the device;
program instructions to determine a number of other messages received within a time period shorter than a threshold time period during which the message is received, the other messages being received from a plurality of devices other than the device;
program instructions to estimate, using a processor and a memory, using a function on the degree of correspondence and the number of other messages, a level of urgency associated with an emergency reported in the call from the device to the emergency service; and
program instructions to make the location data and the level of urgency available to the emergency service.

12. (canceled)

13. The computer usable program product of claim 11, wherein the emergency data profile is configured within the device.

14. The computer usable program product of claim 11, wherein the message comprises textual data.

15. The computer usable program product of claim 11, further comprising:
program instructions to receive the set of past messages over a past period, the past period occurring prior to the period in which the message is received, wherein the pattern comprises an amount of elapsed time between a pair of past messages, and wherein the degree of correspondence indicates that the message arrived after the amount of elapsed time after an earlier message and the location data of the message and location data of the earlier message indicate locations in a common geographical area.

16. The computer usable program product of claim 11, further comprising:
program instructions to receive the set of past messages over a past period, the past period occurring prior to the period in which the message is received, wherein the pattern comprises a sender of a past message in the past messages, and wherein the degree of correspondence indicates that a sender of the message is also a sender of an earlier message.

17. The computer usable program product of claim 11, further comprising:
program instructions to receive the set of past messages over a past period, the past period occurring prior to the period in which the message is received, wherein the pattern comprises a location information contained in a past message in the past messages, and wherein the degree of correspondence indicates that the location data of the message and location data of an earlier message indicate locations in a common geographical area.

18. The computer usable program product of claim 11, wherein the computer usable code is stored in a computer readable storage device in a data processing system, and wherein the computer usable code is transferred over a network from a remote data processing system.

19. The computer usable program product of claim 11, wherein the computer usable code is stored in a computer readable storage device in a server data processing system, and wherein the computer usable code is downloaded over a network to a remote data processing system for use in a computer readable storage device associated with the remote data processing system.

20. A computer system comprising a processor, a computer-readable memory, and a computer-readable storage device, and program instructions stored on the storage device for execution by the processor via the memory, the stored program instructions comprising:
program instructions to receive, from a mobile telecommunication device (device), a message comprising location data and an emergency data item, the message being responsive to a call being initiated to an emergency service from the device;
program instructions to cause the emergency call initiation to compute the location data at the device;
program instructions to cause a construction of the message at the device using an emergency data profile;
program instructions to compute a degree of correspondence between the message and a pattern of messages, the pattern having been computed using a set of past messages from the device;
program instructions to determine a number of other messages received within a time period shorter than a threshold time period during which the message is received, the other messages being received from a plurality of devices other than the device;
program instructions to estimate, using a processor and a memory, using a function on the degree of correspondence and the number of other messages, a level of urgency associated with an emergency reported in the call from the device to the emergency service; and
program instructions to make the location data and the level of urgency available to the emergency service.
